(19) United States
(12) Patent Application Publication
(10) Pub. No.: US 2016/0042616 A1
(43) Pub. Date: Feb. 11, 2016

(54) Child In Vehicle Reminder Alarm

(71) Applicant: Joseph Lawrence Dorsey, Fort Mitchell, KY (US)

(72) Inventor: Joseph Lawrence Dorsey, Fort Mitchell, KY (US)

(21) Appl. No.: 14/452,169

(22) Filed: Aug. 5, 2014

(51) Int. Cl. G08B 7/06; G08B 21/02

(52) U.S. Cl. CPC G08B 7/06; G08B 21/0202

(57) ABSTRACT

An alarm system for reminding a driver of the earlier placement of a child in the backseat of a vehicle usable with both a one piece car seat and a two piece car seat comprised of a carrier and base includes in a first embodiment a rear sensor, driver door opening sensor, a control unit, alarm means, and deactivation switch wherein the opening of a rear door activates and arms the system automatically so consequently the alarm means is energized and activated anytime thereafter when the driver opens their door, thus reminding the driver when they are exiting the vehicle of the child in the back. The driver then deactivates the system manually. In another embodiment applied to a child's two piece car seat includes a car seat occupancy state detector, driver door opening sensor, a control unit, and alarm means, wherein the car seat occupancy state detector is comprised of split components of actuator and sensor which are placed on the carrier and base respectively, thus allowing the user to remove the carrier without needing to remove or disconnect some component of the system first from the carrier and allowing a manufacture to avoid using wireless technology as the means to communicate a signal from the car seat occupancy state detector to the central control unit.

### CROSS REFERENCE TO RELATED APPLICATIONS

This application claims, the benefit of Provisional Patent Application 61/863,161 filed on Aug. 7, 2013 and Provisional Patent Application 61/945,426 filed on Feb. 27, 2014 by the present inventor, which is incorporated by reference.

### BACKGROUND OF THE INVENTION

This invention relates to devices intended to remind or alert parents and caregivers that a child is occupying the back seat of a car or car seat in the back seat of a car when exiting or after having left the vehicle so that the child is not inadvertently forgotten and left behind. Nearly all prior art directed at solving this problem use some unique combination of five elements or components. These are,

First, a means to detect that a child has been placed in the backseat or is present in their car seat. This component functions to arm the system, activating or “waking up” it up upon sensing the child has been placed in the back. Second is a means to detect the driver is exiting or otherwise not present in the vehicle. This component functions to trigger the third component, the alarm means, when the fourth component, a control unit, receives a signal from the child in car detector indicating the child is in the car but at the same time a signal from the driver sensor that the driver is exiting or otherwise absent. In some simpler designs however, there is no control unit and the device is based on simple closing of circuits. The last component is an electrical connection means between the four core components of child in car detector, driver sensor, control unit, and alarm so they can send and receive signals as necessary. Generally speaking, the electrical connection means seen in prior art is either hardwiring the components together or using wireless means such as a RE transmitter and receiver, infrared, or blue tooth technology.

For example, U.S. Pat. No. 7,012,533 to Younse uses what it refers to as a “built in car seat cushion pressure switch means” to detect the child in a one piece car seat, a “door switch” that senses both the opened state and closed state of the driver's door, an internal alarm within the cabin of the vehicle, a micro-controller unit, and it also supplements the system with a temperature sensor in communication with an outside alarm as a backup to the internal alarm. It teaches hard wiring all the components together.

U.S. Pat. No. 7,106,207 to Marchan uses functionally a momentary switch which is refers to as a “contact” switch built into a one piece child's car seat to detect that the child's car seat is occupied, a switch which it refers to as a “push button” switch to detect the opened state and the closed state of the driver's door and which is apparently built into the car door, and shows the components being hardwired together. It has no control unit. When both circuits are closed simultaneously, a circuit to the alarm is completed resulting in the alarm being energized. The alarm is therefore limited to one pattern, sound, and volume.

Patent Application US 2007/0268119A1 by Cran & Cran, shows in its primary embodiment a combination of a “weight sensor being operable for sensing weight applied to a seat and generating a corresponding weight reading” (apparently to ensure that the alarm is not sounded by the weight of the buckles, cushions, or the seat itself if placed under the seat rather than where the child rests), a magnetically actuated switch for detecting the opening of a car door, a control unit, and a RF transmitter for sending the signal from the weight sensor to the control unit that a child is in the car seat. However, it also states that the device in various embodiments can have the components hardwired together as well and the weight sensor can be a removable pad or built into the car seat itself.

Devices like the first two above in which the components are hardwired together enjoy the advantage of less susceptibility to outside interference in comparison to devices which use wireless technology to send and receive signals. They can also be designed wherein they are only energized when the child is in the car seat, thus resulting in much longer battery life or without need of an electrical connection to the car. On the other hand, strictly hardwired designs like these examples have one major disadvantage in that they are not practically usable with 2 piece car seats which consist of a base and a removable, portable carrier which the parent takes the child in and out of the car with. Even if the child detector means is some kind of weight sensor pad that can be taken off the seat, if it is hardwired to the rest of the system, the parent cannot easily take the carrier out of the car unless they are willing to remove the pad each time they take the child out of the car and then put in back in when they return.

Devices employing wireless communication to communicate the signal from the child detector means to the control unit of course have the advantage of being able to be used in 2 piece car seats but at the same time, can manifest another set of issues. For example, in a study published by the Children's Hospital of Philadelphia sponsored by the NHTSA in 2012 titled “Reducing the Potential for Heat Stroke to Children in Parked Motor Vehicles: Evaluation of Reminder Technology”, three devices which communicated wirelessly to a key fob were evaluated in actual field tests. It found in the test runs that the devices gave off “false alarms” while driving even though of course the parent was right in the car with the child, presumably as stray radio waves caused the alarm to be falsely triggered. In addition, the study authors found that the devices components “ . . . were erratic in staying synched with the key fob. The movement of the vehicle along with the motion of the child in the child restraint led to the devices commonly alternating between synchronized and unsynchronized states”. In addition, two of the three products used a weight sensor pad to detect the child. The authors notes “The two pad devices often required adjusting the position of the child to get the device to arm when evaluated statically and in some cases, we were unable to arm the device at all”. In other words, the parent had to wiggle and shift the child around to get the pad to pick up on the child.

### BRIEF SUMMARY OF THE INVENTION

It is the objective of this invention to provide a child in vehicle reminder alarm system that is usable with both a one piece car seat as well as a two piece car seat comprised of a carrier and base but without resorting to wireless technology to communicate the signal from the child detector component to the control unit. For the purposes of this Specification and the appended Claims, an alarm system usable with both a one piece car seat as well as a two piece car seat comprised of a carrier and a base shall be defined to mean an alarm system which if adopted or applied to a two piece car seat does not require the user to detach, remove, replace, disconnect, etc. some component of the system before removing the carrier from the car.

The invention employs two underlying inventive concepts to achieve the above objective.

In the first embodiment, rather than employing some means to directly detect that the child is occupying the car seat, the opening of a rear door is detected as a proxy to infer that a child has been placed in the back. In the second embodiment, the concept is to split the car seat occupancy state detector into two components—an actuator piece moved into position by the placement of the child into the carrier and a sensor which is triggerable by the actuator and locating or building in the actuator on the carrier and the sensor on the base. With this split arrangement, the parent can pick up and remove the carrier from the base but when they return and place the carrier back on its base with the child in the carried, the actuator triggers the sensor located on the base.

### BRIEF DESCRIPTION OF DRAWINGS

FIG. 1 shows a diagram of the electrical components.

FIG. 2 shows a perspective view of my invention in its first embodiment as it is contemplated to be installed in a four door vehicle. Please note that although the vehicle depicted in FIG. 2 is one with a swinging rear passenger door typical of a four door sedan, the same layout could be used just as easily with a vehicle with a sliding rear door such as that found on a mini van.

FIG. 3 summarizes the operating logic.

FIG. 4 shows a schematic concept diagram to illustrate how my invention would be installed in a vehicle with two doors.

FIG. 5 shows one possible configuration for a second embodiment of my invention as applied to a two piece car seat comprised of a carrier and base.

FIG. 6 shows another possible configuration for the second embodiment if built into the carrier and base.

FIG. 7 shows the same configuration for the second embodiment if built in the carrier and base depicted in FIG. 5 with the carrier in position on its base.

FIG. 8 shows a one possible configuration for the second embodiment if structured as an aftermarket part.

FIG. 9 shows another possible configuration for the second embodiment if structured as an aftermarket part.

### DETAILED DESCRIPTION OF INVENTION

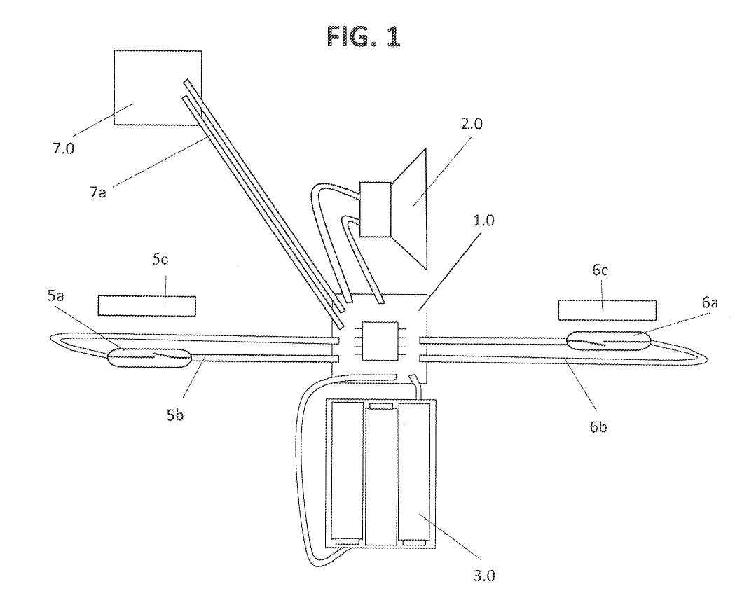

As can be seen in FIG. 1, provided is an alarm system 100 comprised of a control unit 1.0, an alarm means 2.0, a power source 3.0, all of which are contained and integrated into a protective case 4.0 (not show in FIG. 1), at least one rear passenger area accessed sensor 5.0, a driver's door sensor 6.0, and at least one deactivation switch 7.0.

The alarm means 2.0, power source 3.0, rear passenger area accessed sensor 5.0, driver's door sensor 6.0, and deactivation switch 7.0 are all electrically connected to control unit 1.0. Control unit 1.0 is configured to receive inputs or electrical signals from the rear passenger area accessed sensor 5.0, the driver's door sensor 6.0, and deactivation switch 7.0 and send outputs or electrical signals to the alarm means 2.0 which is capable of generating audible or visible output to catch the attention of the parent/driver. In one example embodiment depicted in FIG. 1, the alarm means 2.0 is a speaker 2a with lead wires 2b, the power source 3.0 is a battery or batteries, the rear passenger area accessed sensor 5.0 is a rear reed switch 5a with leads 5b paired with a rear magnet 5c, and the driver's door sensor 6.0 is a front reed switch 6a with leads 6b paired with a front magnet 6c. Rear reed switch 5a and driver's door reed switch 6a function as normally closed type switches. Deactivation switch 7.0 is provided and electrically connected to control unit 1.0 by leads 7a to send inputs or signals to control unit 1.0 and in this example are of the “touch pad” type commonly found in enhanced children's story books that play animal sounds, etc when tapped.

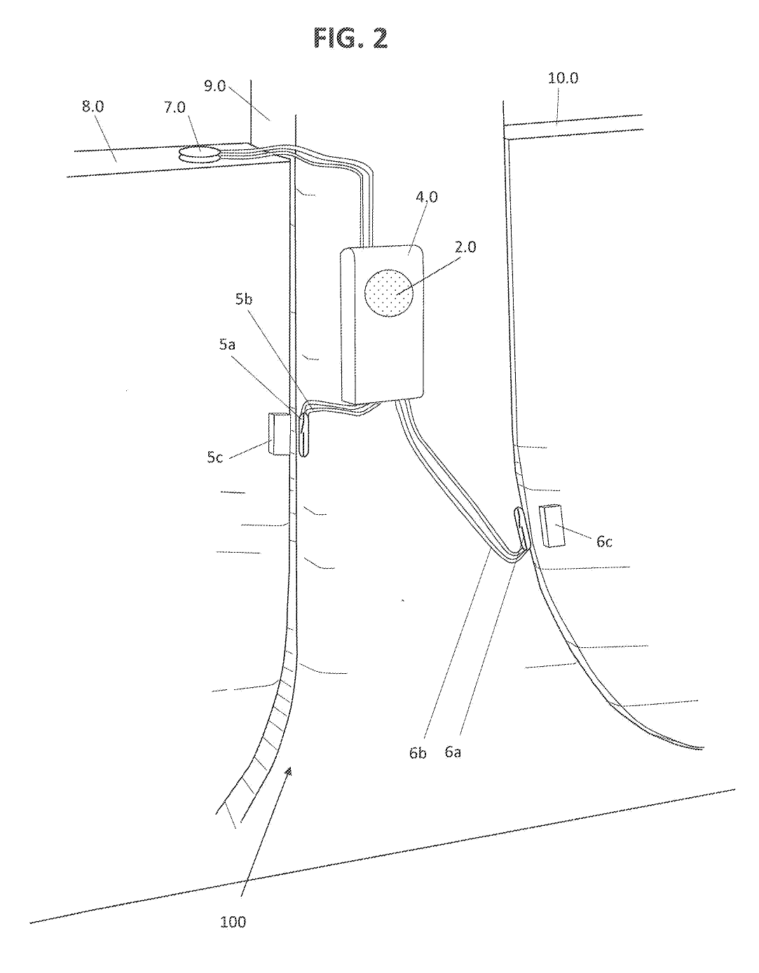

FIG. 2 shows the way the first embodiment of my invention is to be installed in a four door vehicle, such vehicles having a rear passenger door 8.0, a center roof support column 9.0 (or the “B Pillar” as it is referred to in the auto industry), and a driver's door 10.0. As can be seen, the protective case 4.0 housing the control unit 1.0, alarm means 2.0, and power source 3.0 is attached by any suitable means such as tape, glue, hook and loop tape, adhesive strips, double sided foam, etc., to the face of the central roof support column 9.0 so that it is secured from being jostled when the car is moving. Rear reed switch 5a is attached in a similar manner to the outside edge of the central roof support column 9.0 nearest rear door 8.0. Driver's door reed switch 6a is attached to the outside edge of central roof support column 9.0 on the outside edge nearest driver's door 10.0. Rear magnet 5c and front magnet 6c are attached in a similar manner to the outside edge of their respective rear and driver doors nearest the central roof support column 9.0 in alignment with their respective reed switches 5a and 6a, positioned and oriented such so that the gap between the components is sufficiently narrow to result in reed switches 5a and 6a being triggered upon the opening of their respective doors. Although not depicted in FIG. 1 and not necessary for the functioning of alarm system 100, a passenger side rear sensor 5a′, passenger side rear magnet 5c′, and passenger side deactivation switch 7.0′ would normally be provided and attached in the same configuration and manner as just described above to the passenger side central roof support column and passenger side rear door so that both rear doors would be monitored for opening and the driver/parent could arm and deactivate alarm system 1.0 from either side of the vehicle. The wire leads for the passenger side rear sensor 5a′and passenger side deactivation switch 7.0′ would be placed under the carpet mats or below the front seats to keep them protected and from underfoot. In the case of a four door vehicle deactivation switch 7.0 is attached to the top most edge of the interior door panel of rear door 8.0 at the bottom of the window by any suitable means such as tape, glue, hook and loop tape, adhesive strips, double sided foam, etc so as to be within arm's reach and conveniently accessible to the parent when they open the rear door. In the case of a mini van with sliding rear passenger door, it is mounted to the central roof support column 9.0 at a convenient height.

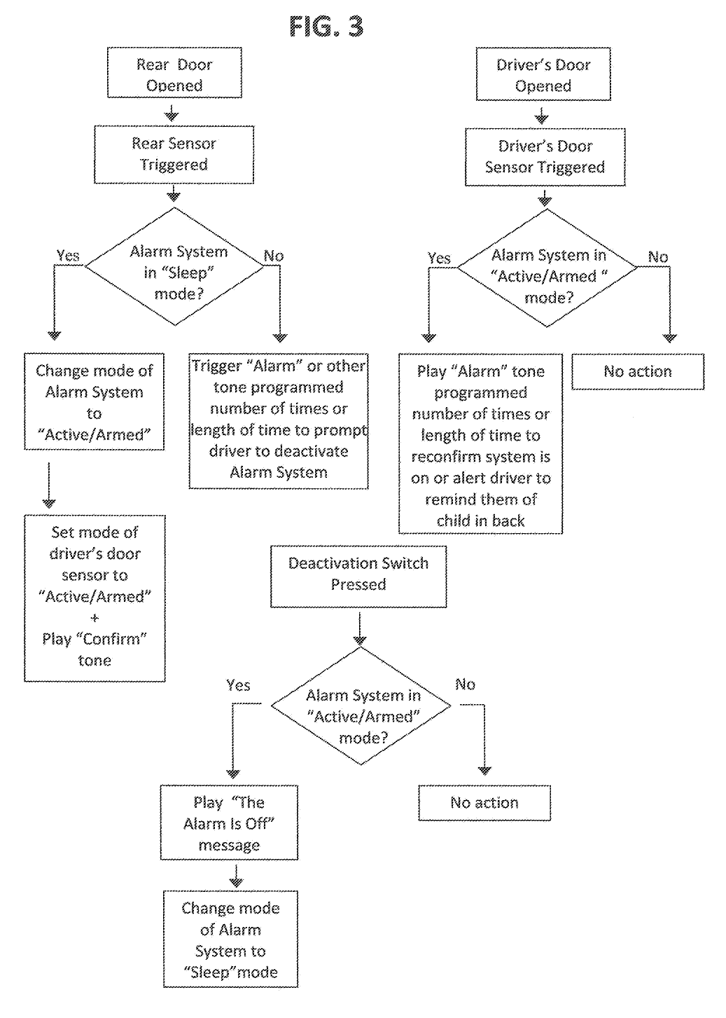

In one possible programming configuration, the control unit 1.0 is programmed to play or trigger a plurality of sounds, tones, or voiced messages by energizing speaker 2a. These sounds are played or triggered in accordance with the operating logic depicted in the flow chart of FIG. 3. In one possible example operating pattern as depicted in FIG. 3, the tones or sounds includes a “confirm tone”, an “alarm tone”, and an “off message”. All of these tones or messages are programmed to play at a certain volume and for a predetermined number of times or length of time with any number of patterns possible but it will be appreciated that the best pattern will balance the need to get the driver's/parent's attention with the need not to be irritating to the adult driver or startle the child when going off.

Referring to FIG. 3, when rear sensor 5a is triggered by the opening of a rear door, the alarm system 100 is put into “active/armed” mode by the controller 1.0 if it is not already in such a mode. Upon the alarm system 100 going into “active/armed” mode, the control unit 1.0 sets the mode of the driver's door sensor 6.0 to “active/armed” thereby arming it and at the same time, triggers the “confirm tone” so that the driver/parent knows that the system has been armed. With driver's door sensor 6.0 now in “active/armed” mode when the parent then opens their driver door 10.0 to get in, the driver's door sensor 6.0 is triggered and in turn the control unit 1.0 plays the “alarm tone” a limited number of times or for a short length of time, e.g, 2× or 5 seconds, as programmed. The playing of the “alarm tone” in this instance where the driver is getting into the vehicle and not exiting serves not to “remind” but to reconfirm that the alarm system 100 is on and working properly before the driver leaves. If the “alarm tone” should not play when the driver is getting in, this will serve as a useful warning that something is wrong, e.g., the front magnet 6c has fallen off, and investigation is needed. After driving and arriving at their destination when the driver/parent opens their driver door, driver's door sensor 6.0 is triggered again resulting in the “alarm tone” sounding, thus reminding the driver that there is still a passenger in the rear. Should this be the true final destination, i.e, not getting out mid-trip to get gas, the parent will retrieve the child and upon opening one of the rear doors to do so, the “alarm tone” will be triggered again. In this case, this will serve to prompt the parent/driver to press the deactivation switch 7.0 which when the parent does, causes the control unit 1.0 to play the “the alarm is off” voice message and put alarm system 1.0 into “sleep” mode. If the parent exits and it is not the final destination but just a temporary stop such as to get gas the alarm will be activated but since the duration or number of times the alarm tone plays is programmed to be limited, the parent does not necessarily need to deactivate it as it should not be irritating to the child or other passengers remaining in the car.

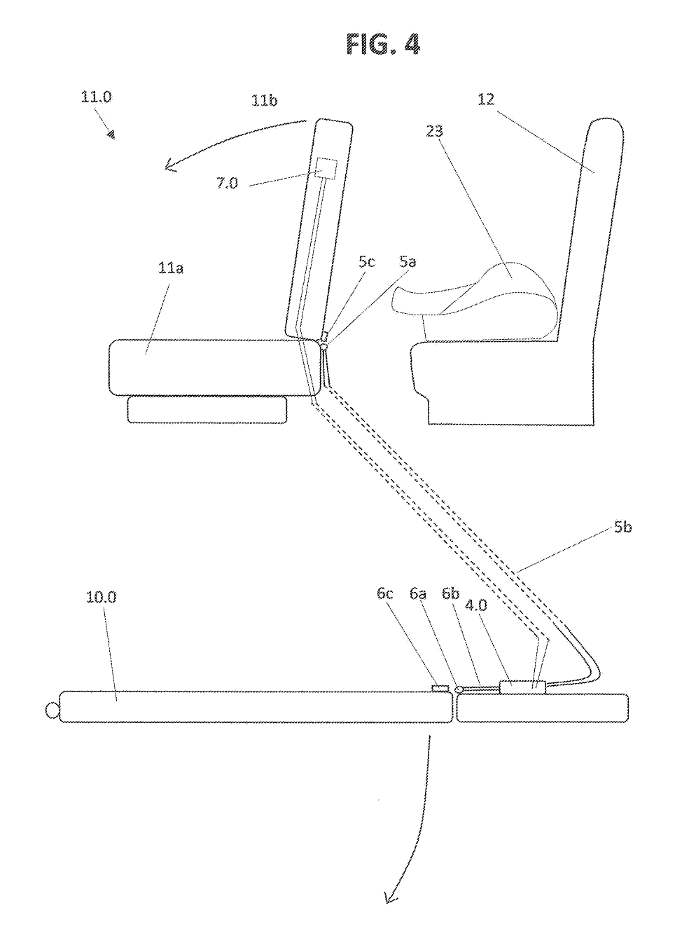

The placement and installation of my invention as illustrated in FIG. 2 is appropriate for four door vehicles. However as shown in FIG. 4's schematic diagram, the installation would be slightly different for a two door vehicle featuring a backseat 12 and a driver's seat 11.0, comprised of seat base 11a and moveable seat back 11b which, as is well known, the driver must flip forward to gain access to backseat 12 so as to be able to place an infant car seat carrier 20 (not shown in FIG. 4) in the backseat. The protective case 4.0 housing the central control unit 1.0, alarm means 2.0, and power source 3.0 is attached to any suitable spot on the interior wall of the vehicle flanking the backseat as depicted in FIG. 4 or alternatively, attached to seat base 11a. Rear reed switch 5a is attached to seat base 11a in either case. Rear magnet 5c is attached to seat back 11b in close enough proximity to rear reed switch 5a and oriented such so as to trigger rear reed switch 5a when moved by the parent flipping the seat back forward. Attached so, when the parent/driver flips their seat back 11b forward, rear magnet 5c moves away from rear reed switch 5a resulting in rear reed switch 5a being triggered and arming/activating the alarm system 100. Front reed switch 6a is attached on the edge of the interior wall facing backseat 12 that is nearest driver's door 10.0 and front magnet 6c is attached to the driver's door 10.0, the two components installed in close enough proximity and oriented such so that front reed switch 6a is triggered when the parent/driver opens driver's door 10.0. Deactivation switch 7.0 is mounted on seat back 11b or other easily reachable spot such as on the vehicle's interior wall facing backseat 12 or on the car seat base 23 itself.

The rear passenger area accessed sensor 5.0 and driver's door sensor 6.0 could be means other than magnetic reed switches, such as Halls Effect sensors, etc. Besides batteries, the power source 2.0 could be an electrical connection configured to engage a vehicle's DC power source.

### First Embodiment

### Detailed Description

In this embodiment, the components are the same as the first embodiment except that the rear passenger area accessed sensor 5.0 and deactivation switch 7.0 are replaced by a car seat occupancy state detector 21.0. In this embodiment, an alarm system that works both with a one piece car seat as well as a two piece car seat is afforded by car seat occupancy state detector 21.0 which is comprised of at least two split components—a occupancy sensor actuator 21a and a occupancy sensor 21b, When this system is applied to a two piece car seat the former is built into or located on the carrier piece and the latter is located on the base, thus making the carrier easily removable but allowing for the occupancy sensor 21b to be hardwired.

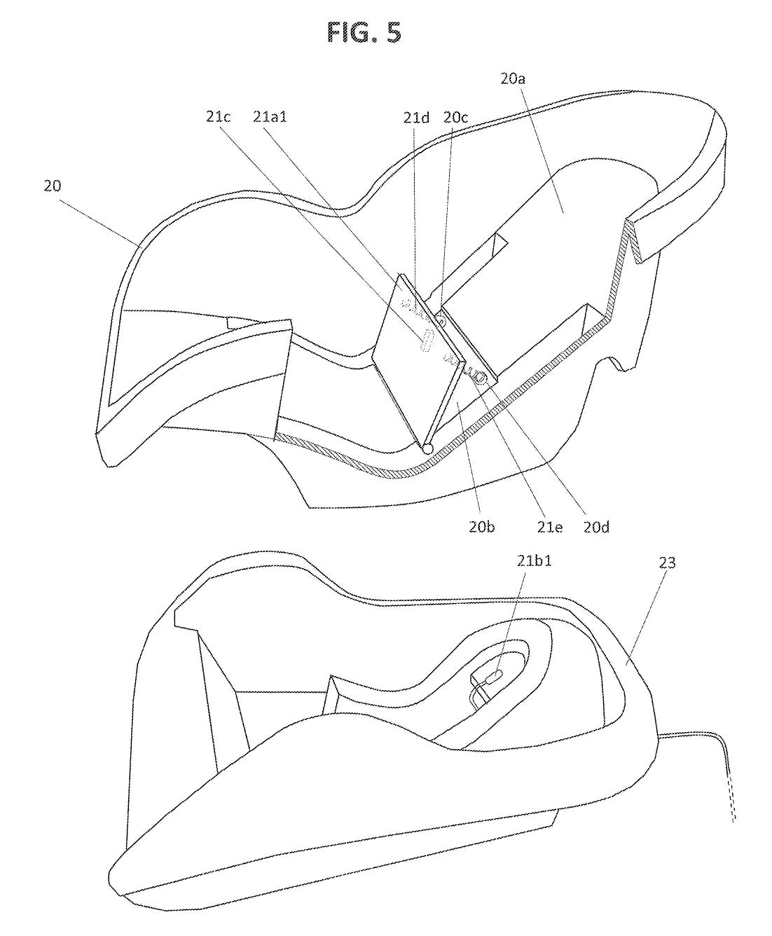

Shown in FIGS. 5-9 are four ways occupancy sensor actuator 21a (labeled 21a1, 21a2, 21a3, 21a4 in the Figs.) can be structured in cooperation with two types of occupancy sensors 21b, those being a magnetically actuated switch such as a reed switch 21b1 shown in the figures or Halls Effect sensor and a momentary switch 21b2.

FIGS. 5, 6, and 7 show possible structures and means if the occupancy sensor actuator 21a is built into the carrier 20, say by a manufacturer who elected to adopt this alarm system for their line of two piece car seats and also wanted the same alarm system to work with their line of one piece of car seats.

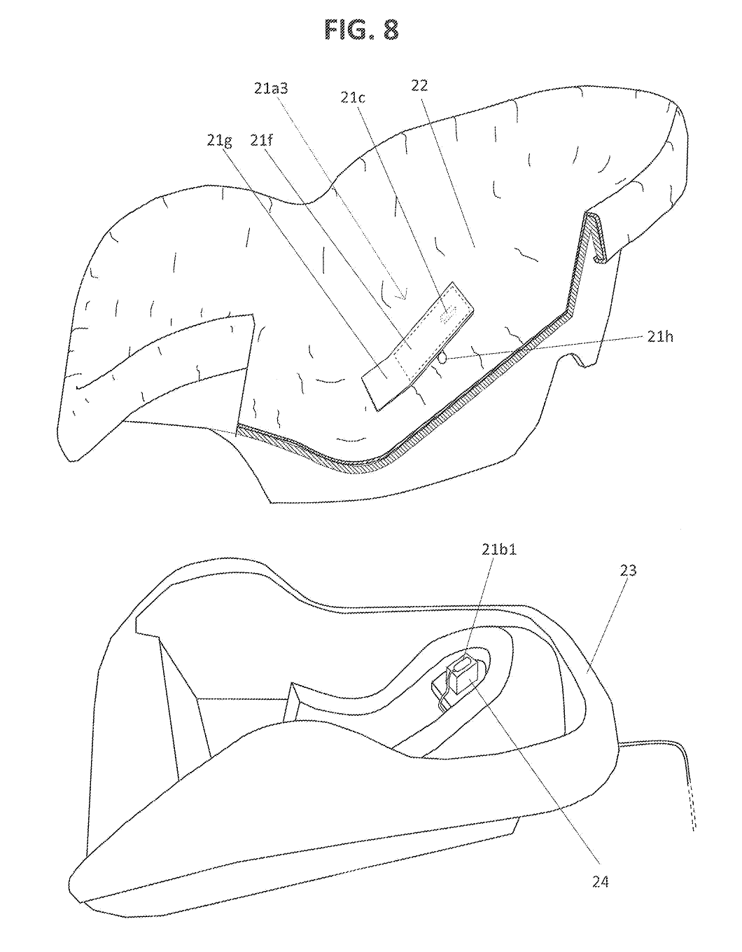

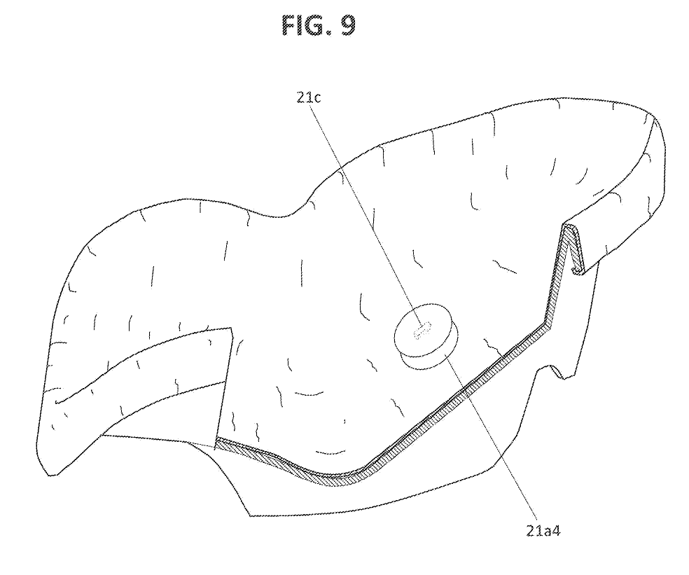

FIGS. 8 and 9 show a possible structure for car seat occupancy state detector 21.0 where a manufacture could “add on” alarm system 100 to their existing line of car seats by simply sewing or otherwise attaching a component to a car seat cover 22 as will be illustrated. Likewise a consumer could do the same for a car seat they already own.

Note that in FIGS. 5-9 the side walls of carrier 20 and base 23 are cut away for ease of viewing.

The first suggested way to structure occupancy sensor actuator 21a is shown in FIG. 5 and may be summed up as “a seat flap configured with a magnet and built into the carrier”. In this example, car seat carrier 20 is designed with a built in seat flap 21a1. Affixed to the underside of seat flap 21a1 and to the car seat carrier 20 are compression springs 21d and 21e. In addition, magnet 21c is embedded into seat flap 21a1. Also seen is carrier base 23 upon which magnetic reed switch 21b1—is attached. Magnetic reed switch 21b1 functions as a normally open type switch in all cases of this second embodiment of alarm system 100.

In the example configuration for seat flap 21a1 shown in the figure, seat flap 21a1 presents a profile when viewed from the lateral side as a rectangular plane with a three quarters round rod shape along one edge with the upper plane of the seat flap 21a1 tangent to the three quarters round rod shape and the lower plane bisecting the center point of the rod shape. The rod shape functions as an axis about which seat flap 21a1 rotates. As can be seen in FIG. 5, the portion of the car seat carrier constituting where the baby's body rests upon (which for purposes of this description shall be referred to as the “carrier floor” 20a) is formed with an indenture 20b in its profile that matches up with the profile of the underside of seat flap 21a1. Its form also incorporates cup holder like spring recesses 20c and 20d into which springs 21d and 21e can compress and fully recede into.

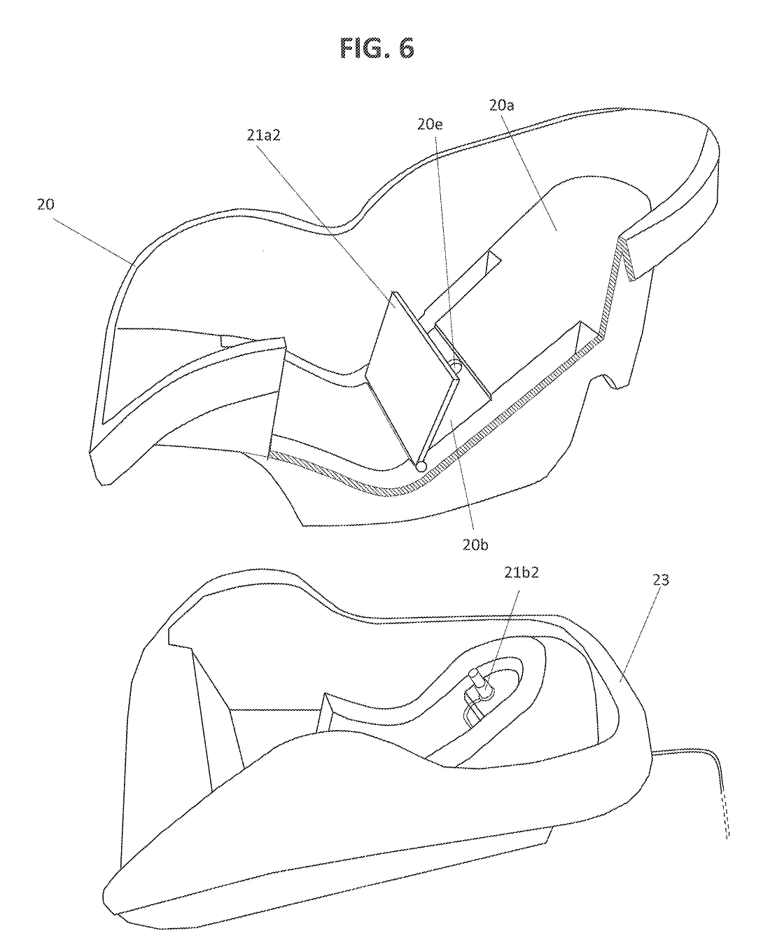

When no child is in the carrier 20 seat flap 21a1 is biased by compression springs 21d and 21e to rotate about its rod like axis portion to extend upwardly and away from carrier floor 20a so magnet 21c is in a non-actuating or non-triggering position. Resilient shape retaining deformable foam, elastic band, or weights could also be employed to accomplish the same upward urging function. However when a child is placed in the car seat carrier 20, the intrusion of the child's body causes seat flap 21a1 to rotate downwards and nest in indenture 20b as shown in FIG. 6 wherein it more or less lies flush with the carrier floor 20a so that a substantially smooth surface is provided for the child's comfort and it is positioned into an actuating state. Conversely, base 23 is formed and molded so as to provide a place where reed sensor 21b1 is positioned within triggering proximity when seat flap 21a1 and its embedded magnet 21c is in actuating position. Thus if the parent places the child into carrier 20 and then places the carrier with child onto base 23 magnetic reed switch 21b1 is actuated and alarm system 100 is put in active/armed mode. Conversely if the child or the carrier with child still inside is removed, alarm, system 100 is put in sleep mode.

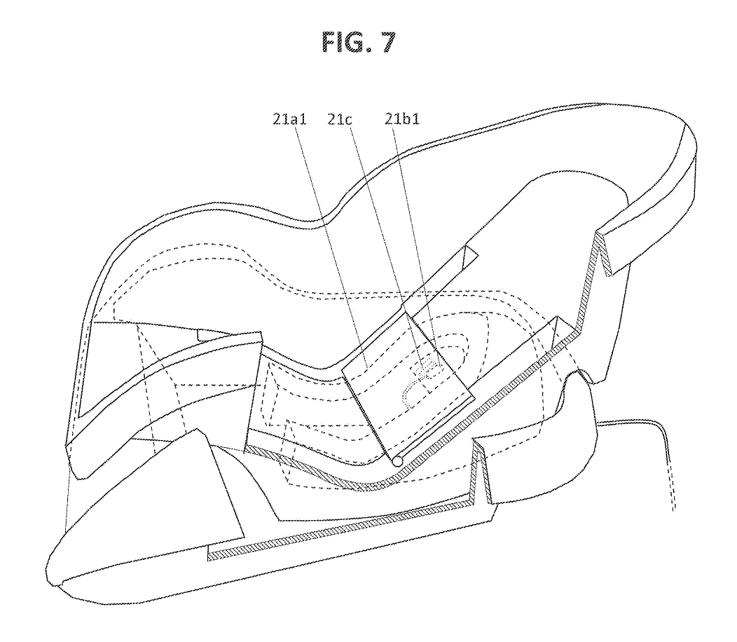

Though not shown in FIGS. 5 & 6, it is standard practice for all infant car seats to come with a form fitting seat cover 22 (see FIG. 7) that is tailored to fit over the carrier so as to provide a soft surface for the child to be laid upon. This being the case, it is understood that the seat cover would be tailored as necessary to accommodate and not hinder the upward and downward movement of seat flap 21a1.

The second suggested way to structure occupancy sensor actuator 21a is shown in FIG. 7 and may be summed up as “a seat flap configured with no magnet and built into the carrier”. It is mean to be used in cooperation with a momentary push button type switch 21b2. in this case, carrier 20 is provided with a hole 20e through which the top portion of momentary push button type switch 21b2 protrudes above the plane of seat carrier floor 20a and upon which seat flap 21a2 rests in a non-actuating manner. Seat flap 21a2 is identical to seat flap 21a1 except it has no magnet embedded or attached to it. When the child is placed in carrier 20, seat flap 21a2 is moved downward into actuating position and momentary push button switch 21b2 actuated.

The third possible way to structure occupancy sensor actuator 21a can be described as “a seat flap configured with a magnet and attachable to a seat cover of a car seat”. This structure is one that affords a manufacturer or a consumer the ability to add alarm system 100 to their existing line of car seats or one which the consumer already owns. It is comprised of a resilient board 21f covered and encased within a cavity formed by tailored padded cover 21g forming an “upper” portion and leaving a “lower” portion which is affixed to the seat cover using any suitable attachment means such as glue, sewing, adhesive strips, hook & loop tape, etc so that the “upper” portion encasing resilient board 21f is free to swing up and away or down and towards car seat base 23 to lay substantially flat on cover 22 when fully depressed. Magnet 21c is embedded within resilient board 21f. Shape retaining deformable foam cylinder 21h, made of mattress foam or packing foam to give an example, functions as a spring, urging the “upper” portion away from the base 23. A spring, elastic band, or weights could also be employed to accomplish the same upward urging function

Magnetic reed sensor 21b1 is attached to base 23 or if necessary, a spacer 24 which in turn is attached to base 23. To explain the function of spacer 24, different manufacture's car seat carriers and their matching bases will exhibit varying sizes of gaps between underside of the car seat carrier 21 and the base 23, including situations wherein the gap is too wide for the desired triggering or actuating action to occur if reed switch 21b1 is attached directly to base 23. To accommodate a variety of such situations and bring rear reed switch 21b1 to its maximum possible closeness to the underside of car seat carrier 20, i.e., flush against the underside, spacer 24 is provided which can be seen in FIG. 8. Such a spacer 24 would most advantageously be of a deformable but shape retaining material such as mattress or packing foam, sponge, clay, or a Play-doh like substance. If made of clay for example, in application the user would form an overly large block of the spacer material, place it on the appropriate location of base 23 that corresponds to where magnet 21c will be positioned above it when occupancy sensor actuator 21a3 is depressed, imbed reed sensor 21b1 slightly on top of the ball of material, and then place car seat carrier 20 onto its base 23. This action will result in the reed switch being embedded into and held in place by the clay material of spacer 24 while at the same time lying flush against the underside of carrier 20. Alternatively, if made of foam, the shape and form of spacer 24 could be molded with an open or closed recess at the top conforming tightly to the shape of reed switch 21b1 and its lead wires into which it would be inserted and held therein either by friction fit or with adhesive. Space 24 could also be a spring.

A last simplified design of occupancy sensor actuator 21a is shown in FIG. 9. It is comprised of a foam block 21a4 made of resilient shape retaining deformable foam or as it is sometime more commonly referred to, mattress or packing foam, with magnet 21c. Magnet 21c is embedded within foam block 21a4 towards the top end. Adhesive strips (not shown in FIG. 9) are provided on its underside for affixing it to seat cover 22 or the same could be achieved by shaping foam block 21a4 to friction fit into the space against the walls of carrier 20. Alternatively, foam block 21a4 is placed underneath seat cover 22 and adhered directly onto base 23 wherein a lump is formed under seat cover 22. In either case, the body of the child when placed in the car seat depresses and compresses foam block 21a4 thereby bringing magnet 21c into triggering proximity to reed switch 21b1.

I claim:

1. An alarm system usable with both a one piece car seat as well as a two piece car seat comprised of a carrier piece and a base for reminding an operator of a vehicle with a rear door or a vehicle with two doors and a folding driver's seat that an occupant is still present in a rear passenger area of the vehicle, comprising:
a. a rear passenger area accessed sensor that detects when a rear door of the vehicle with a rear door is opened or that a seatback of the folding driver's seat of the two door vehicle is moved or flipped forward, for generating a signal to put the system into active armed mode
b. a driver's door sensor for detecting when a driver's door of a vehicle is opened
c. a power source for powering the alarm system
d. a deactivation switch manually actuated, for generating a signal for putting the alarm system in sleep mode
e. a programmed control unit responsive to the rear passenger area accessed sensor, for automatically putting the alarm system in an active, armed mode when the rear door has been opened or driver's folding seat seatback flipped forward and responsive to the driver's door sensor, for automatically generating an alert signal when the driver's door has been opened if the alarm system is in active armed mode and responsive to the signal from the deactivation switch, for putting the alarm system in a sleep mode
f. an alarm responsive to generation of the alert signal, for reminding the operator of the presence of the occupant in the rear of the vehicle.

2. The alarm system of claim 1 wherein the rear passenger area accessed sensor is a reed switch and magnet or a Halls Effect sensor and magnet

3. The alarm system of claim 1 wherein the driver's door sensor is a reed switch and magnet or a Halls Effect sensor and magnet

4. The alarm system of claim 1 wherein the power source is a battery or an electrical connector configured to engage a vehicle direct current power source.

5. The alarm system of claim 1 wherein the alarm is a speaker or lights.

6. The alarm system of claim 1 wherein the vehicle has another rear door or another folding seat; and another rear passenger area accessed sensor for detecting when the other rear door has been opened or another folding seat seatback flipped forward; and another deactivation switch manually actuated, configured to generate a signal when actuated; and wherein the control unit is also responsive to the other rear sensor, for automatically putting the alarm system in an active armed mode when the other rear door has been opened or passenger side folding seat seatback flipped forward; and also responsive to the signal from the other deactivation switch, for putting the alarm system in a sleep mode.

7. An alarm system usable with both a one piece car seat as well as a two piece car seat comprised of a carrier piece and a base for reminding an operator of a vehicle that an occupant is still present in a car seat in the rear passenger area of the vehicle, comprising:
a. A car seat occupancy state detector comprised of an occupancy sensor actuator and cooperating occupancy sensor wherein when the alarm system is adopted for use with a two piece car seat the occupancy sensor actuator is located on the carrier of the two piece car seat and cooperating occupancy sensor is located on the base, for generating a signal for putting the alarm system into active armed mode or sleep mode.
b. a driver's door sensor for detecting when a driver's door of a vehicle is opened
c. a power source for powering the alarm system
d. a programmed control unit responsive to the signal from the car seat occupancy state sensor, for automatically putting the alarm system in an active armed mode when the occupancy sensor is in an actuated state and for putting the alarm system in a sleep mode when the occupancy sensor is not in an actuated state and responsive to the driver's door sensor, for automatically generating an alert signal when the driver's door has been opened if the alarm system is in active armed mode.
e. an alarm responsive to generation of the alert signal, for reminding the operator of the presence of an occupant in a car seat in the rear of the vehicle.

8. The occupancy sensor actuator of claim 7 wherein the occupancy sensor actuator is a seat flap configured with or without a magnet and built into the carrier, a seat flap configured with a magnet and permanently attachable to a seat cover of a car seat, or a shape retaining deformable foam member configured with a magnet.

9. The seat flap configured with or without a magnet and built into the carrier and seat flap configured with a magnet and attachable to a seat cover of a car seat of claim 8 wherein the said seat flap configured with or without a magnet and built into the carrier and seat flap configured with a magnet and attachable to a seat cover of a car seat is configured to be pivotable into a sensor actuating position in relationship to the occupancy sensor by the placement of a child in a car seat or into a sensor non-actuating position in relationship to the occupancy sensor by the removal of the child from the car seat.

10. The occupancy sensor of claim 7 wherein the occupancy sensor is either a reed switch, a Halls Effect sensor, or a momentary switch.

11. The occupancy sensor of claim 7 wherein the occupancy sensor is configured to communicate the signal from the occupancy sensor to the control unit by electrical wire.

12. The occupancy sensor of claim 7 wherein the occupancy sensor is held or urged into contact with the underside of the carrier piece of the two piece car seat by foam, clay, or a spring.
